(19) United States
(12) Patent Application Publication
(10) Pub. No.: US 2008/0004883 A1
(43) Pub. Date: Jan. 3, 2008

(54) Scalable audio coding

(75) Inventors: Miikka Vilermo, Tampere (FI); Mikko Tammi, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/479,994

(22) Filed: Jun. 30, 2006

(51) Int. Cl. G10L 19/00

(52) U.S. Cl. 704/500

(57) ABSTRACT

A method and related apparatus for generating a scalable layered audio stream, whereby the method comprises: encoding an input audio signal with a low bitrate audio encoding technique to generate a base layer of a layered data stream representing the audio signal; and producing a plurality of enhancement layers into the layered data stream, at least one of the enhancement layers comprising a coded version of at least a part of the input audio signal rendering at least one of the lower layers comprising low bitrate audio encoded data redundant for decoding the audio signal.

### FIELD OF THE INVENTION

The present invention relates to audio coding, and more particularly to an enhanced scalable audio coding scheme.

### BACKGROUND OF THE INVENTION

The recent development in communication technology has made streaming high-fidelity audio a reality not only in wired networks, but also in wireless channels and networks. The so-called third generation (3G) mobile networks and all future generation networks, as well, are being developed into so-called all IP networks, wherein Internet Protocol (IP) based architecture is used to provide all services, such as voice, high-speed data, Internet access, audio and video streaming, in IP networks. However, from the viewpoint of delivering audio, IP networks and especially wireless IP networks involve the serious drawback that the available bandwidth of an IP network is typically rather limited and, moreover, it is varying in time.

Various kinds of scalable audio coding schemes have been developed to accommodate the varying bandwidth of wireless IP networks. A scalable audio bitstream typically consists of a base layer and at least one enhancement layer. It is possible to use only a subset of the layers to decode the audio with lower sampling resolution and/or quality. This allows bit-rate scalability, i.e. decoding at different audio quality levels at the decoder side or reducing the bitrate in the network by traffic shaping or conditioning. The encoding of the scalable audio bitstream can be carried out e.g. such that the base layer encoding provides only a mono signal, and the first enhancement layer encoding adds stereo quality to the audio. Then depending on the capabilities of the receiver device comprising the decoder, it is possible to choose to decode the base layer information only or to decode both the base layer information and the enhancement layer information in order to generate stereo sound. In streaming applications, streaming servers and network elements may selectively adjust the number of delivered layers in a scalable audio bitstream to adapt to network bandwidth fluctuation and packet loss level. For example, when the available bandwidth is low or the packet loss ratio is high, only the base layer could be transmitted.

In addition to the layered scalable coding, another type of scalable coding called fine-grain scalable coding has been used to achieve a scalable audio bitstream. In fine-grain coding useful increases in coding quality can be achieved with small increments in bitrate, usually from 1 bit/frame to around 3 kbps. The most common technique in fine-grain scalable coding is the use of bit planes, whereby in each frame coefficient bit planes are coded in order of significance, beginning with the most significant bits (MSB's) and progressing to the least-significant bits (LSB's). A lower bitrate version of a coded signal can be simply constructed by discarding the later bits of each coded frame. The codecs based on fine-grain coding are efficient at a narrow range of bitrates, but the contemporary IP environment, wherein receiving devices with very different audio reproduction capabilities are used, requires audio streams with rather wide range of bitrate scalability. In such an environment, the efficiency of fine-grain coding reduces significantly.

In layered scalable coding, each layer typically codes the difference between the original and the sum of previous layers. The problem with layered coding is that when each layer is coded separately, typically further including some side information, this causes an overhead to the overall bitrate. Thus every additional layer, while increasing the attainable audio quality, makes the codec more inefficient.

The problem of developing a scalable audio codec that achieves high efficiency at a wide range of bitrates has been discussed in “The Reference Model Architecture for MPEG Spatial Audio Coding,”, J. Herre et al., the 118th Convention of the Audio Engineering Society, Barcelona, May 2005 (preprint 6447). The reference model RM0 presented in the document is based on spatial audio coding, whereby a wide range of bitrate scalability is achieved through various mechanisms of parameter scalability, on one hand, and residual coding on the other hand. The basic idea is to use parametric representations of sound as basic audio components, whereby scalability is provided by varying the resolution and granularity of parameters. In order to further enhance the scalability and the attainable audio quality, residual signals representing parametric errors are coded and transmitted in the bitstream along the parametric audio in scalable fashion. These residual signals can be used to improve the audio quality, but if the available bitrate is low, the residual signals can be left out and the decoder automatically reverts to the parametric operation.

However, one of the problems in the presented reference model RM0 is that the parametric audio description is always used as a basic component of the coded audio stream. It is generally known that parametric coding schemes have limited scalability, and thus, using parametric coding as a basic component does not provide the most efficient scalability.

### SUMMARY OF THE INVENTION

Now there is invented an improved method and technical equipment implementing the method, which provide both a good coding efficiency and a wide range of bitrate scalability. Various aspects of the invention include a method, an apparatus and a computer program, which are characterized by what is stated in the independent claims. Various embodiments of the invention are disclosed in the dependent claims.

According to a first aspect, a method according to the invention is based on the idea of encoding an input audio signal with a low bitrate audio encoding technique to generate a base layer of a layered data stream representing said audio signal; and producing a plurality of enhancement layers into said layered data stream, at least one of the enhancement layers comprising a coded version of at least a part of the input audio signal rendering at least one of the lower layers comprising parametric audio data redundant for decoding the audio signal.

According to an embodiment, the method further comprises: encoding the base layer of the layered data stream as a mid channel downmix of a plurality of audio channels according to some low bitrate audio encoding technique.

According to an embodiment, the method further comprises: encoding at least one of the enhancement layers of the layered data stream as a side information related to said mid channel downmix.

According to an embodiment, the parametric audio encoding technique is parametric stereo (PS) encoding or binaural cue coding (BCC) encoding.

According to an embodiment, the method further comprises: encoding the base layer of the layered data stream according to a low bitrate waveform coding or a low bitrate transform coding scheme.

According to an embodiment, the method further comprises: encoding at least one of the enhancement layers of the layered data stream as a bandwidth extension to at least one of the lower layer signals having a bandwidth narrower than the input audio signal.

According to an embodiment, the method further comprises: encoding at least one of the enhancement layers comprising the coded version of at least a part of the input audio signal as a replacement for a low-frequency subband of a lower layer parametric audio data.

According to an embodiment, the method further comprises: encoding at least one of the enhancement layers comprising the coded version of at least a part of the input audio signal as a replacement for the psychoacoustically most important subbands of a lower layer parametric audio data.

According to an embodiment, the method further comprises: producing at least one enhancement layer into said layered data stream, which enhancement layer improves the decodable audio quality of the enhancement layer comprising the coded version of at least a part of the input audio signal.

The arrangement according to the invention provides significant advantages. A major advantage is that the scalable coding system according to the embodiments achieves nearly the same coding efficiency as the best codecs today but on a particularly wide range of bitrates. The good coding efficiency stems from the fact that the bitstream involves redundant coding layers, which do not necessarily have to be transmitted and/or decoded, when an upper layer enhancement is desired for decoding. On the other hand, a further advantage can be achieved if at least a part of the lower layers with parametric representation are transmitted along the coded layers, whereby the scalable signal can be used for error concealment by recovering an error on a high level layer with the corresponding part of the signal on a lower level layer.

According to a second aspect, there is provided an apparatus comprising: a first encoder unit for encoding an input audio signal with a low bitrate audio encoding technique to generate a base layer of a layered data stream representing said audio signal; and one or more second encoder units for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

According to a third aspect, there is provided a computer program product, stored on a computer readable medium and executable in a data processing device, for generating a scalable layered audio stream, the computer program product comprising: a computer program code section for encoding an input audio signal with a low bitrate audio encoding technique to generate a base layer of a layered data stream representing said audio signal; and a computer program code section for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

These and other aspects of the invention and the embodiments related thereto will become apparent in view of the detailed disclosure of the embodiments further below.

### BRIEF DESCRIPTION OF THE DRAWINGS

In the following, various embodiments of the invention will be described in more detail with reference to the appended drawings, in which

FIG. 1 shows an embodiment of layer scalable coding in relation to mono/stereo coding;

FIG. 2 shows a table representing the embodiment of FIG. 1 from the viewpoint of a decoding apparatus;

FIG. 3 shows a reduced block chart of a data processing device, wherein a scalable audio encoder and/or decoder according to the invention can be implemented;

FIG. 4 shows a reduced block chart of an encoder according to an embodiment of the invention; and

FIGS. 5a-5c show reduced block charts of decoders according to some embodiments of the invention.

### DESCRIPTION OF EMBODIMENTS

The basic concept of the invention is to use some low bitrate coding technique, preferably parametrically coded representations of an audio signal as a low quality layer and then gradually replace the parametric representation with a coded version of the signal on the enhancement layers. Herein and throughout this disclosure, the terms “coded version of the signal” or “coded channel” refer to non-parametrically coded representation of the signal, i.e. preferably waveform coded or transform coded version of the signal. Furthermore, it is notified that even though a parametrically coded signal may be considered the most preferable low bit rate coding technique for the base layer, the basic idea of the invention is not limited to that only, but any other low bitrate coding technique, such as low bitrate waveform coding or transform coding, can be used on the lower layers as well.

However for the sake of perspicuity and simplicity, the following disclosure is mainly focused on the embodiments, wherein parametric coding is used as the low bitrate coding technique on lower layers. In this respect, the gradual replacement described above means that the base layer is provided, for example, with a parametrically coded signal having a limited bandwidth (e.g. 0-8 kHz), and then on the enhancement layers the bandwidth is expanded and simultaneously the attainable audio quality is enhanced in a plurality of steps. For example, in relation to bandwidth this basic idea of the invention could be implemented such that first a bandwidth extended (BWE) version is created from the parametrically coded base layer signal having the limited bandwidth to provide also the high-frequency information of the audio, and then the BWE version of the high-frequency information is replaced with coded version band-by-band starting from the lowest frequency band. In relation to the audio quality of stereo reproduction this could mean that the parametric stereo information provided on lower layers are gradually replaced with coded Side channel information on the higher enhancement layers. In relation to the audio quality of multi-channel audio reproduction this could mean that parametric information is gradually replaced by coded channels, starting from the most important channels and lowest frequencies.

According to an embodiment, the coded layers do not necessarily represent the highest attainable audio quality, but there can also be enhancement layers to the coded layers. In such a case the coded layers preferably use some form of traditional scalable coding, i.e. fine-grain scalable coding or layered scalable coding. Some examples of fine-grain scalable coding schemes are given in documents S. H. Park et al., “Multi-Layer Bit-Sliced Bit Rate Scalable Audio Coding,” presented at the 103rd Convention of the Audio Engineering Society, New York, September 1997 (preprint 4520), and J. Li, “Embedded Audio Coding (EAC) with Implicit Psychoacoustic Masking”, ACM Multimedia 2002, pp. 592-601, Nice, France, Dec. 1-6, 2002. A layered scalable coding scheme, in turn, is discussed in the document Vilermo et al., “Perceptual Optimization of the Frequency Selective Switch in Scalable Audio Coding,” presented at the 114th Convention of the Audio Engineering Society, Amsterdam, March 2003 (preprint 5851)

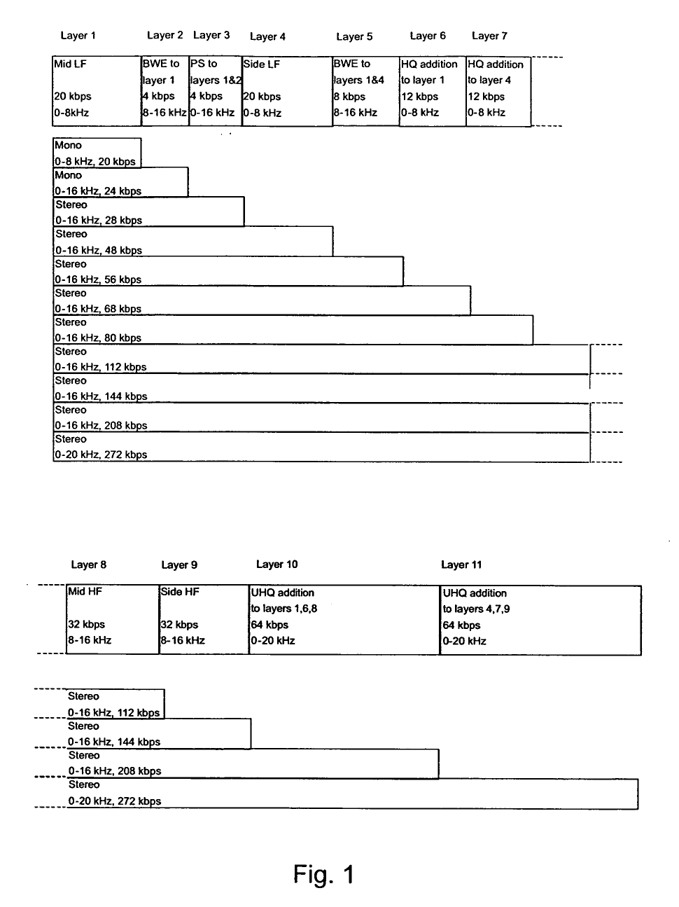

The basic ideas underlying the various embodiments are best illustrated by examples. FIG. 1 shows an embodiment in relation to mono/stereo coding. As stated above, the lower layers, i.e. the base layer and at least some of the lowest enhancement layers, preferably take advantage of parametrically coded representations of an audio signal. Parametric stereo (PS) is a coding tool that, instead of coding the two channels of stereo audio separately, codes only one mono channel and some parametric information on how the stereo channels are related to the mono channel. The mono channel is usually a simple downmix of the two stereo channels. The parametric information has two sets of data: one that relates the created Mid channel (e.g. defined as Mid Channel=½ Left channel+½ Right channel) to the original Left channel and one that relates the created Mid channel to the original Right channel. In this embodiment, layer 1 is coded as a narrow band (0-8 kHz) mono downmix of the incoming audio signal, the downmix having bitrate of 20 kbps.

Bandwidth extension (BWE) is a coding tool that usually codes some parametric information about the relation of a low frequency band to a higher frequency band. This parametric information requires far less bits than e.g. transform coding the higher band. Typically this could mean a reduction from 24 kbps to 4 kbps. Instead of coding the higher frequency band, it is recreated in the decoder from the low frequency band with the help of the parametric information. A known bandwidth extension technique is called Spectral Band Replication (SBR) technology, which is an enhancement technology, i.e. it always needs an underlying audio codec to hook upon. Thus, SBR can also be used in combination with conventional waveform audio coding techniques, like mp3 or MPEG AAC, as is disclosed in the document Ehret et al., “State-of-the-art Audio Coding for Broadcasting and Mobile Applications”, presented at the 114th Convention of the Audio Engineering Society, Amsterdam, March 2003 (preprint 5834).

The basic idea of SBR is to allow the recreation of the high frequencies using only a very small amount of transmitted side information, whereby the high frequencies do not need to be waveform coded anymore, which results in a significant coding gain. Furthermore, the underlying waveform coder can run with a comparatively high SNR, e.g. at the optimum sampling rate for creating the lower frequencies. The optimum sampling rate for the lower frequencies is typically different from the desired output sampling rate, but SBR converts the waveform codec sampling rate into the desired output sampling rate by down/upsampling the waveform codec sampling rate appropriately.

In this embodiment, layer 2 is a mono BWE to layer 1, calculated from the narrow band mono downmix signal of layer 1. The BWE of layer 2 extends the bandwidth of the audio signal to 16 kHz, but increases the total bitrate by only 4 kbps, the aggregate of layers 1 and 2 being 24 kbps.

Layer 3, in turn, is a parametric stereo coding to layers 1 and 2. It is calculated from the bandwidth extended low frequency mono signal, i.e. layer 1 and the BWE of layer 2. Layer 3 now provides a stereo signal with the bandwidth of 16 kHz, but only with a total bitrate of 28 kbps.

Layer 4 is a coded version of Side channel in low frequencies (i.e. 0-8 kHz). Layer 4 is used to replace the parametric stereo coding of layer 3 in low frequencies, thus enhancing the audio quality on the frequency band of 0-8 kHz, but the lower quality stereo signal of layer 3 can still be used in the audio reproduction on the higher frequency band 8-16 kHz. The replacement of the parametric stereo coding of layer 3 in low frequencies is performed in the decoder by taking the Mid channel from layer 1 and Side channel from 4.

The Left and Right channels can be calculated using e.g. formulas Mid channel=(1-a)*Left channel+a*Right channel, and Side channel=(1-a)*Left channel−a*Right channel, wherein a=0 . . . 1, which give a general expression of Mid/Side channel information. As a special case, wherein a=½, the Left and Right channels in the low frequencies are calculated using formulas Mid channel=½ Left channel+½ Right channel, and Side channel=½ Left channel−½ Right channel. The audio quality enhancement provided by layer 4 on the lower frequency band increases the total bitrate by 20 kbps, the aggregate encoded bitsteam of layers 1-4 now being 48 kbps. It should, however, be noted that if only higher quality audio on the lower frequency band is desired, the decoder needs only layers 1 and 4, whereby the total bitrate of 40 kbps would suffice.

Now when we have a higher quality stereo signal on the lower bandwidth on layer 4, we can create a stereo BWE to the higher bandwidth by utilizing the PS Mid channel information on layer 1 and the coded Side channel information on layer 4. Accordingly, layer 5 replaces the BWE in layer 2 and the PS in layer 3. This provides various alternatives for achieving bitrate scalability. Coding the difference between layers 2 and 5 instead of sending layer 5 results in some bitsavings. Alternatively, the layers 2 and 3 can still be used and layer 5 omitted. Also, layer 5 can be sent in place of layer 2, whereby instead of using layer 2, the bandwidth extension for layer 1 is created by applying layer 5 separately for layer 1, adding the results together and dividing by 2.

A skilled man appreciates that, instead of parametric stereo coding, also any other stereo coding scheme, even the traditional way of coding the two channels of stereo audio separately, can be used, if considered necessary.

If some traditional scalable coding scheme is used, then it is possible to add layers to improve the quality of the non-parametric layers. In this example, layers 6 and 7 are used for this purpose; layer 6 provides a high-quality (HQ) addition to layer 1, i.e. to the narrow band mono downmix on the parametric stereo coding Mid channel, and layer 7 provides a high-quality addition to layer 4, i.e. to coded low frequency Side channel information. Now, if layers 6 and 7 are used to improve the signal provided by layers 1 and 4, then the BWE in layer 5 can be calculated from the improved signal, thus improving the quality of the BWE in layer 5 as well. Alternatively, new BWE information could be sent.

Layers 8 and 9 are coded versions of Mid channel and Side channel in higher frequencies (i.e. 8-16 kHz), and they are used to replace the bandwidth extended signal from layer 5 in those higher frequencies. Finally, provided that some traditional scalable coding is used on layers 8 and 9, layers 10 and 11 further improve the quality of the whole signal throughout all (low and high) frequencies and they expand the frequency range further to 20 kHz.

According to an embodiment, the same kind of layered scalable structure can be used in relation to multi-channel audio coding. Likewise, a plurality of multi-channel coding schemes may be provided, whereby the layers presented above may be used to deliver multi-channel audio information with a variety of audio quality. The multi-channel coding schemes with the lowest audio quality and bitrate may preferably take advantage of Binaural Cue Coding (BCC), which is a highly developed parametric spatial audio coding method. BCC represents a spatial multi-channel signal as a single (or several) downmixed audio channel and a set of perceptually relevant inter-channel differences estimated as a function of frequency and time from the original signal. The method allows for a spatial audio signal mixed for an arbitrary loudspeaker layout to be converted for any other loudspeaker layout, consisting of either same or different number of loudspeakers. BCC results in a bitrate, which is only slightly higher than the bitrate required for the transmission of one audio channel, since the BCC side information requires only a very low bitrate (e.g. 2 kbps).

According to an embodiment, the first multi-channel coding scheme MC1 involves a BCC coding where spatial information of the five audio channels and one low frequency channel of the 5.1. multi-channel system is applied to one core codec channel only, i.e. BCC5-1-5 coding. The parametric spatial information of the MC1 is provided on layers 1 and 2, whereby layer 1 provides a narrow band (0-8 kHz) downmixed audio channel, which is bandwidth extended by layer 2 up to 16 kHz. Due to the very efficient downmix process and very low bitrate side information, the BCC5-1-5 coding, requiring a bitrate of 16 kbps as such, results in a total bitrate of only 40 kbps, i.e. including layer 1, layer 2 and MC1.

Then the second multi-channel coding scheme MC2 can involve an enhanced BCC coding where spatial information of the 5.1. multi-channel system is applied to two core codec channel, i.e. BCC5-2-5 coding, which requires a bitrate of only 20 kbps. Using two core codec channels instead of one increases the total bitrate only to 64 kbps, i.e. including layer 1, layer 4, layer 5 and MC2.

According to an embodiment, the third multi-channel coding scheme MC3 does not utilize BCC coding any more, but rather the difference between the original 5.1 Left and Right channels to the downmixed Left and Right that were used to create layers 1 and 4 as described above. The MC3 coding scheme can then further involve coded data for a low frequency band (0-8 kHz) also for the remaining channels of the 5.1. multi-channel system; i.e. center channel C, Left surround channel LS, Right surround channel RS, and Low Frequency Effect channel LFE. Furthermore, the MC3 coding scheme preferably involves a BWE for all these channels.

According to an embodiment, the fourth multi-channel coding scheme MC4 provides a high quality multi-channel coding by improving the MC3 such the BWEs of each channel in the MC3 are replaced with coded data.

Then the fifth multi-channel coding scheme MC5 can provide an ultra high quality enhancement to the MC4 in a similar manner as layers 10 and 11 described above, i.e. by improving the quality of the whole signal throughout all frequencies and expanding the frequency range further to 20 kHz.

According to an embodiment, the multi-channel layers MC3 and MC4 can further be split into smaller layers by sending most important channels and lowest frequencies first and using the previous layer in the perceptually less relevant regions.

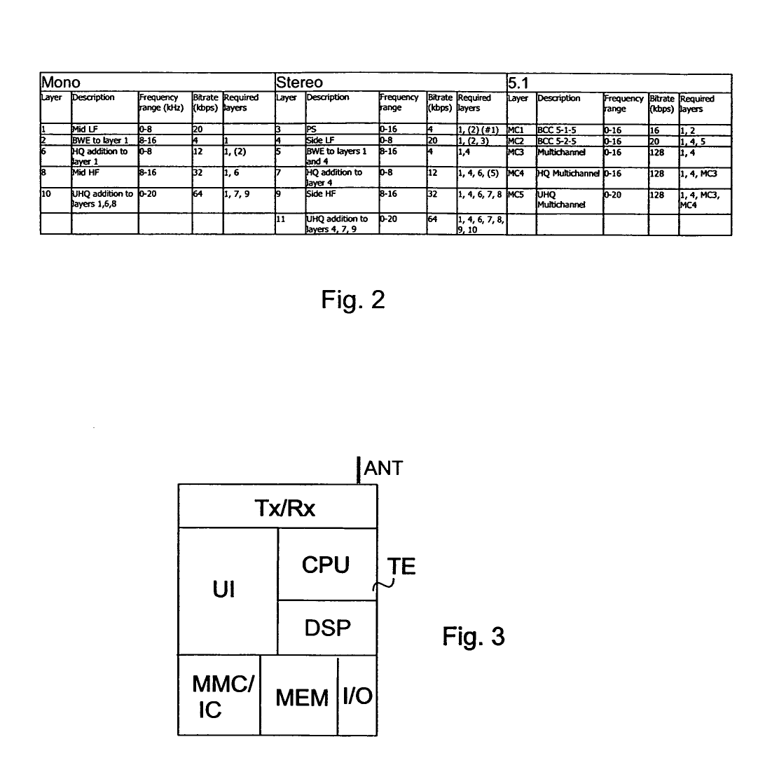

The example presented in FIG. 1 can also be illustrated with the table in FIG. 2. The contemplation of the table should be regarded from the viewpoint of a decoding apparatus, whereby the user of the apparatus may set his preferences about the number of channels (mono/stereo/multi-channel, such as 5.1), the bandwidth and the available or desired bitrate. A suitable option can then be found from the table in FIG. 2.

If the difference between parametric representation and original is never used i.e. higher quality layers always completely discard the parametric representation, then sending parametric layers is not necessary when aiming for higher quality. The table in FIG. 2 is drawn assuming this.

On the other hand, if the lower layers with parametric representation, or at least a part of them, are transmitted along the coded layers, this kind of scalable signal can advantageously be used for error concealment. For example, if an error is found when decoding a high level layer, it may be possible to replace it by decoding the corresponding part of the signal on a lower level layer. Thus, transmitting at least part of lower layers along the coded layers may be a default setting for the operation, but the transmitting apparatus and the receiving apparatus, such as a mobile station, may agree, e.g. with mutual handshaking, on discarding the parametric layers, if the capabilities of the receiving apparatus and the network parameters allow the decoding of the coded layers only.

If the decoding apparatus of the user is, for example, a plain mobile phone with only monophonic audio reproduction means, the user may desire, or the apparatus may automatically select, to receive only a high quality mono audio signal for typical frequency range of speech, whereby the lower frequencies (0-8 kHz) would suffice. From the table of FIG. 2 it can be seen that layers 1 and 6 are required to produce a high quality mono audio signal for the lower frequencies, whereby the bitrate would aggregate to 32 kbps. Layers in parenthesis in the “Required layers” column indicate layers that are not necessary but that would create a higher bandwidth signal if used. Thus, with a minor increment of 4 kbps, the user would optionally receive the BWE of layer 2, which would extend the bandwidth of the audio signal to 16 kHz.

As another example, if the decoding apparatus of the user is a more advanced mobile phone with stereophonic audio reproduction means, e.g. a plug for stereo headphones, but the user has only a connection with a limited bandwidth, e.g. an audio streaming connection in an IP network allowing only a bitrate of less than 50 kbps, the user may want to maximise the audio quality with the rather minimized bitrate. Again, from the table of FIG. 2 it can be seen that layers 1 and 4 would produce a high quality stereo audio signal for the lower frequencies, and the BWE of layer 5 would then extend the bandwidth of the stereo signal to 16 kHz. The combination of layers 1, 4 and 5 would then aggregate to the total bitrate of 44 kbps. Alternatively, if the decoding apparatus of the user comprises multi-channel audio reproduction means, a high quality stereo audio signal could be provided through the multi-channel coding scheme MC2, i.e. by BCC5-2-5 coding, with the total bitrate of only 64 kbps.

It is apparent for a skilled man that the scalable coding schemes disclosed above are merely examples of how to organise the layered structures such that the parametric representations are gradually replaced by coded versions of the signal, and depending on the parametric coding schemes and scalable coding schemes used, the desired number of layers, available bandwidth, etc., there are a plurality of variations for organising the layered structures. Thus, a skilled man appreciates the parametric stereo (PS) and Binaural Cue Coding (BCC) are only mentioned as examples of the parametric coding schemes applicable in various embodiments, but the invention is not limited to said parametric coding schemes solely. For example, the invention may be utilized in MPEG surround coding scheme, which as such takes advantage of the above-mentioned PS and BCC scheme, but further extends them. Furthermore, as mentioned earlier, the basic idea of the invention is not limited to using a parametrically coded signal as the low bitrate coded signal on lower layers only, but any other low bitrate coding technique, such as low bitrate waveform coding or transform coding, can be used on the lower layers as well. Moreover, the order of the encoding steps, i.e. encoding the different layers, may vary from that what is described above. E.g. the steps of creating the parametric stereo signal and those of creating the BWE signal may be carried out in different order than what is described above.

As an example regarding the variations for organising the layered structures, in the embodiment of FIG. 1 above, the parametric stereo coding on layer 3 is applied to layers 1 and 2 to create a 0-16 kHz stereo signal. However, in the “Required layers” column of the table the sign (#1) means that parametric stereo coding on layer 3 can also be applied to layer 1 only to create a 0-8 kHz stereo signal. Thus, according to an embodiment, layer 3 can be further divided into two layers: one that creates stereo for low frequencies and one that creates stereo for high frequencies. Also the first layer can be scalable in itself too; the first layer may consist of e.g. a speech coding layer dedicated for coding typical speech signals and a more general audio coding enhancement layer.

Also different bandwidth regions can be improved separately. Perceptually there is usually no reason to improve the quality of a higher frequency region without improving lower frequency regions first, but this can be done.

According to an embodiment, when a parametric signal is replaced with a coded signal, the replacement can be started from the psychoacoustically most important bands or the bands that the parametric information has constructed badly, instead of the lowest frequency bands.

According to an embodiment, it is not always necessary to use a coded version of the signal on the upper enhancement layers to achieve improvements in audio quality. For example, if the parametric representation comes close to the original signal, it may take less bits to encode the difference between the original and parametric representations instead of coding the original, thus improving the coding efficiency.

According to an embodiment, the number of enhancement layers is not restricted by any means, but new layers can always be added up to lossless quality. If some layers extend the signal to very high frequencies, resampling of the signal between layers may become necessary.

A skilled man appreciates that any of the embodiments described above may be implemented as a combination with one or more of the other embodiments, unless there is explicitly or implicitly stated that certain embodiments are only alternatives to each other.

The arrangement according to the invention provides significant advantages. A major advantage is the scalable coding system according to the embodiments achieves nearly the same coding efficiency as the best codecs today but on a particularly wide range of bitrates; i.e. both a good coding efficiency and a wide range of bitrate scalability can be achieved. The good coding efficiency stems from the fact that the bitstream involves redundant coding layers, which do not necessarily have to be transmitted and/or decoded, when an upper layer enhancement is desired for decoding. On the other hand, a further advantage can be achieved if at least a part of the lower layers with parametric representation are transmitted along the coded layers, whereby the scalable signal can be used for error concealment by recovering an error on a high level layer with the corresponding part of the signal on a lower level layer.

FIG. 3 illustrates a simplified structure of a data processing device (TE), wherein a scalable audio encoder and/or decoder according to the invention can be implemented. The data processing device (TE) can be, for example, a mobile terminal, a PDA device or a personal computer (PC). The data processing unit (TE) comprises an input/output module (I/O), a central processing unit (CPU) and memory (MEM). The memory (MEM) comprises a read-only memory ROM portion and a rewriteable portion, such as a random access memory RAM and FLASH memory. The information used to communicate with different external parties, e.g. a CD-ROM, other devices and the user, is transmitted through the I/O module (I/O) to/from the central processing unit (CPU). If the data processing device is implemented as a mobile terminal, it typically includes a transceiver Tx/Rx, which communicates with the wireless network, typically with a base transceiver station (BTS) through an antenna. User Interface (UI) equipment typically includes a display, a keypad, a microphone and a connector for headphones. The microphone and the loudspeaker can also be implemented as a separate hands-free unit. The data processing device may further comprise connecting means MMC, such as a standard form slot, for various hardware modules, which may provide various subunits or applications to be run in the data processing device.

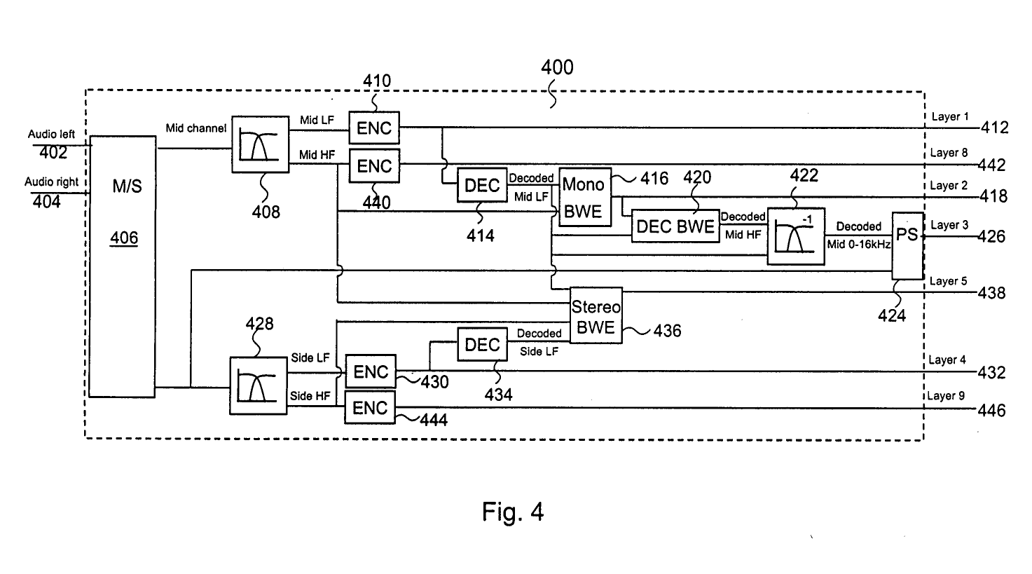

FIG. 4 illustrates a simplified structure of a scalable audio encoder according to an embodiment, which can be implemented in the data processing device (TE) described above. The structure of the audio encoder reflects the operation of the embodiments disclosed in FIGS. 1 and 2, whereby the lower layers of the scalable audio stream are encoded with parametric encoding. The encoder 400 comprises separate inputs 402, 404 for the left audio channel and the right audio channel, through which inputs the audio signals are fed into mono/stereo extracting unit 406, which generates a mono downmix of the two input channels, i.e. the Mid channel, and the respective side information, i.e. the Side channel.

For generating the layer 1 signal, the Mid channel signal is fed into a first filtering unit 408 (e.g. a filter bank), which band-pass filters only the lower frequencies (i.e. 0-8 kHz) of the Mid channel signal to be further fed into a first encoder 410, which encodes the layer 1 output signal 412 as a narrow band mono downmix of the incoming audio signal with a bitrate of approximately 20 kbps.

As mentioned above, the layer 2 signal is a bandwidth extension of the layer 1 mono signal. Accordingly, the layer 1 output signal 412 is decoded with a first decoder 414 in order to generate a decoded Mid channel signal on lower frequencies (i.e. 0-8 kHz). The decoded Mid channel signal is fed into a mono bandwidth extension unit 416 together with the higher frequencies (i.e. 8-16 kHz) of the Mid channel signal received from the first filtering unit 408. On the basis of this higher frequency information, the mono bandwidth extension unit 416 encodes the layer 2 output signal 418 to comprise parametric information about how the higher frequency band relates to the lower frequency band.

The layer 3 signal provides a parametric stereo coding for the bandwidth extended mono signal of layers 1 and 2. For generating the layer 3 signal, the parametric information of the layer 2 output signal 418 is fed into a bandwidth extension decoder unit 420, which outputs a decoded Mid channel signal on the higher frequency band. This, together with the decoded Mid channel signal on the lower frequency band received from the output of the first decoder 414, is fed into a combining unit 422, which combines the signals in order to generate a Mid channel signal for the whole frequency band (0-16 kHz). This decoded Mid channel signal is fed, together with the Side channel information received from the output of the mono/stereo extracting unit 406, into a parametric stereo coding unit 424, which creates the layer 3 output signal 426.

The layer 4 signal provides a coded version of the Side channel information on the lower frequency band. Generating the layer 4 signal resembles generating the layer 1 signal, with the exception that instead of the Mid channel signal, now the Side channel signal is processed. Accordingly, the Side channel signal, received from the output of the mono/stereo extracting unit 406, is fed into a second filtering unit 428, which band-pass filters only the lower frequency band (i.e. 0-8 kHz) of the Side channel signal to be further fed into a second encoder 430, which encodes the layer 4 output signal 432 as an audio enhancement for the lower frequency band.

The layer 5 signal, in turn, is a stereo bandwidth extension of the stereo low-band signal provided as combination of the layer 1 signal and layer 4 signal. Now the layer 4 output signal 432 is decoded with a second decoder 434 in order to generate a decoded Side channel signal on the lower frequency band. The decoded Side channel signal is fed into a stereo bandwidth extension unit 436 together with the decoded low-band Mid channel signal received from the first decoder 414. In order to generate the stereo bandwidth extension, information about higher frequencies (i.e. 8-16 kHz) is required as well. Thus, the higher frequency component of the Mid channel signal is received from the first filtering unit 408 and the higher frequency component of the Side channel signal is received from the second filtering unit 428. Now the stereo bandwidth extension unit 436 is enabled to encode the layer 5 output signal 438 to comprise parametric information, which extend the stereo impression also to the higher frequency band.

In the embodiments disclosed in FIGS. 1 and 2, layers 6 and 7 are used to provide quality enhancement layers to the lower non-parametric layers. For the sake of simplicity, the layers 6 and 7 have been left out from the FIG. 4, since their implementation is very straightforward: they only require, as their inputs, a decoded output and an input of the lower layer for which they provide the quality enhancement. For the same reason, also layers 10 and 11 have been let out from the FIG. 4.

Regarding the layer 8 signal, it provides a coded version of the Mid channel signal on the higher frequency band. Thus, the higher frequency band (i.e. 8-16 kHz) of the Mid channel signal, received from the first filtering unit 408 is fed into a third encoder 440, which encodes the layer 8 output signal 442 as a higher frequency band representation of the incoming audio signal. The layer 8 signal can be used to replace the layer 5 signal, either alone or together with the layer 9 signal.

The layer 9 signal provides a coded version of the Side channel signal on the higher frequency band. Consequently, the higher frequency band of the Side channel signal, received from the second filtering unit 428 is fed into a fourth encoder 444, which encodes the layer 9 output signal 446 as a higher frequency band representation of the Side channel signal to be used together with the layer 8 signal.

The encoder 400 itself, or the data processing device TE wherein the encoder is implemented, typically further comprises a combining unit (not shown) for combining the base layer and one or more of the enhancement layers into a scalable layered audio stream. The encoder 400 can be implemented in the data processing device TE as an integral part of the device, i.e. as an embedded structure, or the encoder may be a separate module, which comprises the required encoding functionalities and which is attachable to various kind of data processing devices. The required encoding functionalities may be implemented as a chipset, i.e. an integrated circuit and a necessary connecting means for connecting the integrated circuit to the data processing device.

A skilled man readily recognizes that the scalable layered audio coding scheme described above provides a plurality of options to supply optimally encoded audio data to decoder apparatuses having different kind of decoding and audio reproduction characteristics. Some examples of such decoding apparatuses are discussed herein briefly.

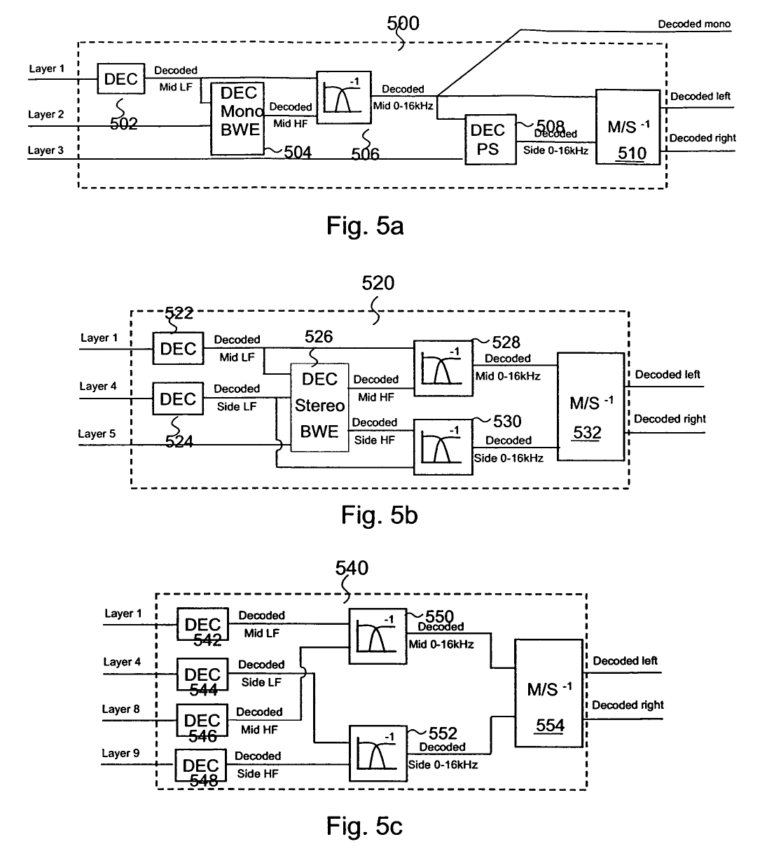

The first decoder 500 disclosed in FIG. 5a receives signals from the layers 1, 2 and 3. The layer 1 signal is decoded with a decoder 502 in order to generate a decoded Mid channel signal on the lower frequencies LF (i.e. 0-8 kHz). The decoded Mid channel signal is fed into a mono bandwidth extension decoder unit 504 together with the layer 2 signal comprising the parametric information about the relationship of the higher frequency band and the lower frequency band. The mono bandwidth extension decoder unit 504 produces a decoded Mid channel signal on the higher frequency band HF (i.e. 8-16 kHz). Then the decoded Mid channel signals, both the LF and HF, are input in a combining unit 506, which combines the signals in order to generate a Mid channel signal for the whole frequency band (0-16 kHz). This decoded Mid channel signal can now be output as a monophonic signal via appropriate reproduction means, if desired.

However, the decoded Mid channel signal can be further processed in order to produce a stereo audio signal. For this purpose, the decoded Mid channel signal is fed, together with the layer 3 signal comprising the parametric stereo coding for the bandwidth extended mono signal of layers 1 and 2, into a parametric stereo decoder 508. As an output of the parametric stereo decoder 508, decoded Side channel information is generated, which is then fed into a mono/stereo composing unit 510, together with the decoded Mid channel signal. The mono/stereo composing unit 510 then produces a decoded stereo signal for the left and right audio channel. Thus, the decoder 500 comprises the functionalities of both a mono decoder and a stereo decoder.

The second decoder 520 disclosed in FIG. 5b receives signals from the layers 1, 4 and 5. Again, the layer 1 signal is decoded with a first decoder 522 in order to generate a decoded Mid channel signal on the lower frequency band LF. The layer 4 signal comprising the coded version of the Side channel signal on the lower frequency band is fed into a second decoder 524, which generates a decoded Side channel signal on the lower frequency band LF. Then both the decoded Mid channel signal and the decoded Side channel signal are fed into a stereo bandwidth extension decoder unit 526 together with the layer 5 signal comprising the stereo bandwidth information. The stereo bandwidth extension decoder unit 526 produces decoded Mid channel signal and decoded Side channel signal on the higher frequency band HF, after which the decoded Mid channel signals on LF and HF are fed into a first combining unit 528, which combines the signals in order to generate a Mid channel signal for the whole frequency band (0-16 kHz). Respectively, the decoded Side channel signals on LF and HF are fed into a second combining unit 530, which combines the signals in order to generate a Side channel signal for the whole frequency band. Then the Mid channel signal and the Side channel signal are input in a mono/stereo composing unit 532, which produces a decoded stereo signal for the left and right audio channel.

The decoder 540 disclosed in FIG. 5c illustrates a third example of decoder functionalities, wherein the decoder 540 receives signals from the layers 1, 4, 8 and 9. As disclosed above, the layers 1, 4, 8 and 9 comprise, respectively, a Mid channel signal on LF, a Side channel signal on LF, a Mid channel signal on HF and a Side channel signal on HF. Each of these encoded signals are fed into an appropriate decoder 542, 544, 546, 548, whereby decoded versions of these signals are generated. Then the decoded signals are processed similarly as in the decoder 520 of FIG. 5b: the decoded Mid channel signals on LF and HF are fed into a first combining unit 550, and the decoded Side channel signals on LF and HF are fed into a second combining unit 552, after which the combined Mid channel signal and the combined Side channel signal are input in a mono/stereo composing unit 554 in order to produce a decoded stereo signal for the left and right audio channel.

It is apparent that the decoder structures given in FIGS. 5a-5c are merely some examples of how the decoder can be implemented. A skilled man appreciates that the decoder may comprise functionalities for decoding an applicable combination of the layers. On the other hand, even though the FIGS. 5a-5c show the decoder as receiving only some layers, the decoder typically receives the whole audio stream, but it decodes only the layers required for a particular purpose and discards the rest of the layers.

The functionality of the invention may be implemented in a terminal device, such as a mobile station, most preferably as a computer program which, when executed in a central processing unit CPU, affects the terminal device to implement procedures of the invention. Functions of the computer program SW may be distributed to several separate program components communicating with one another. The computer software may be stored into any memory means, such as the hard disk of a PC or a CD-ROM disc, from where it can be loaded into the memory of mobile terminal. The computer software can also be loaded through a network, for instance using a TCP/IP protocol stack.

It is also possible to use hardware solutions or a combination of hardware and software solutions to implement the invention. Accordingly, the above computer program product can be at least partly implemented as a hardware solution, for example as ASIC or FPGA circuits, in a hardware module comprising a connector module for connecting the hardware module to an electronic device and various techniques for performing said program code tasks, said techniques being implemented as hardware and/or software.

It is obvious that the present invention is not limited solely to the above-presented embodiments, but it can be modified within the scope of the appended claims.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
encoding an input audio signal with a low bitrate audio encoding technique to generate a base layer of a layered data stream representing said audio signal; and
producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

2. The method according to claim 1, further comprising:
encoding the base layer of the layered data stream as a mid channel downmix of a plurality of audio channels according to some low bitrate audio encoding technique.

3. The method according to claim 2, further comprising:
encoding at least one of the enhancement layers of the layered data stream as a side information related to said mid channel downnmix.

4. The method according to claim 2, wherein the parametric audio encoding technique is parametric stereo encoding or binaural cue coding encoding.

5. The method according to claim 1, further comprising:
encoding the base layer of the layered data stream according to a low bitrate waveform coding or a low bitrate transform coding scheme.

6. The method according to claim 1, further comprising:
encoding at least one of the enhancement layers of the layered data stream as a bandwidth extension to at least one of the lower layer signals having a bandwidth narrower than the input audio signal.

7. The method according to claim 1, further comprising:
encoding at least one of the enhancement layers comprising the coded version of at least a part of the input audio signal as a replacement for a low-frequency subband of a lower layer audio data.

8. The method according to claim 1, further comprising:
encoding at least one of the enhancement layers comprising the coded version of at least a part of the input audio signal as a replacement for the psychoacoustically most important subbands of a lower layer audio data.

9. The method according to claim 1, further comprising:
producing at least one enhancement layer into said layered data stream, which enhancement layer improves the decodable audio quality of the enhancement layer comprising the coded version of at least a part of the input audio signal.

10. An apparatus comprising:
a first encoder unit for encoding an input audio signal with a low bitrate audio encoding technique to generate a base layer of a layered data stream representing said audio signal; and
one or more second encoder units for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

11. The apparatus according to claim 10, wherein:
the first encoder unit is configured to encode the base layer of the layered data stream as a mid channel downmix of a plurality of audio channels according to some parametric audio encoding technique.

12. The apparatus according to claim 11, further comprising:
a second encoder unit for encoding at least one of the enhancement layers of the layered data stream as a side information related to said mid channel downmix.

13. The apparatus according to claim 11, wherein the parametric audio encoding technique is parametric stereo encoding or binaural cue coding encoding.

14. The apparatus according to claim 10, wherein:
the first encoder unit is configured to encode the base layer of the layered data stream according to a low bitrate waveform coding or a low bitrate transform coding scheme.

15. The apparatus according to claim 10, further comprising:
a second encoder unit for encoding at least one of the enhancement layers of the layered data stream as a bandwidth extension to at least one of the lower layer signals having a bandwidth narrower than the input audio signal.

16. The apparatus according to claim 10, further comprising:
a second encoder unit for encoding at least one of the enhancement layers comprising the coded version of at least a part of the input audio signal as a replacement for a low-frequency subband of a lower layer audio data.

17. The apparatus according to claim 10, further comprising:
a second encoder unit for encoding at least one of the enhancement layers comprising the coded version of at least a part of the input audio signal as a replacement for the psychoacoustically most important subbands of a lower layer audio data.

18. The apparatus according to claim 10, further comprising:
a second encoder unit for producing at least one enhancement layer into said layered data stream, which enhancement layer is configured to improve the decodable audio quality of the enhancement layer comprising the coded version of at least a part of the input audio signal.

19. A computer program product, stored on a computer readable medium and executable in a data processing device, for generating a scalable layered audio stream, the computer program product comprising:
a computer program code section for encoding an input audio signal with a low bitrate audio encoding technique to generate a base layer of a layered data stream representing said audio signal; and
a computer program code section for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

20. An audio encoder comprising:
a first encoder unit for encoding an input audio signal with a low bitrate audio encoding technique to generate a base layer of a layered data stream representing said audio signal; and
one or more second encoder units for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

21. The audio encoder according to claim 20, wherein:
the first encoder unit is configured to encode the base layer of the layered data stream as a mid channel downmix of a plurality of audio channels according to some parametric audio encoding technique.

22. The audio encoder according to claim 21, further comprising:
a second encoder unit for encoding at least one of the enhancement layers of the layered data stream as a side information related to said mid channel downmix.

23. The audio encoder according to claim 21, wherein the parametric audio encoding technique is parametric stereo encoding or binaural cue coding encoding.

24. The audio encoder according to claim 20, wherein:
the first encoder unit is configured to encode the base layer of the layered data stream according to a low bitrate waveform coding or a low bitrate transform coding scheme.

25. A module, attachable to a data processing device and comprising an audio encoder, the audio encoder comprising:
a first encoder unit for encoding an input audio signal with a low bitrate audio encoding technique to generate a base layer of a layered data stream representing said audio signal; and
one or more second encoder units for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

26. The module according to claim 25, wherein:
the module is implemented as a chipset.

27. An audio decoder arranged to decode at least one layer of a layered data stream encoded according to the method of claim 1.

28. An apparatus comprising:
means for encoding an input audio signal with a low bitrate audio encoding technique to generate a base layer of a layered data stream representing said audio signal; and
means for producing a plurality of enhancement layers into said layered data stream, at least one of the enhancement layers comprising a coded version of at least a part of the input audio signal rendering at least one of the lower layers comprising low bitrate audio encoded data redundant for decoding the audio signal.

29. The apparatus according to claim 28, wherein:
the means for encoding is configured to encode the base layer of the layered data stream as a mid channel downmix of a plurality of audio channels according to some parametric audio encoding technique.

30. The apparatus according to claim 29, further comprising:
means for encoding at least one of the enhancement layers of the layered data stream as a side information related to said mid channel downmix.
